(19) United States
(12) Patent Application Publication
(10) Pub. No.: US 2019/0229602 A1
(43) Pub. Date: Jul. 25, 2019

(54) STATOR OF LINEAR ELECTRICAL SUBMERSIBLE PUMP UNIT AND METHOD FOR ITS OPERATION

(71) Applicant: Dmytro KHACHATUROV, Kharkov (UA)

(72) Inventor: Dmytro KHACHATUROV, Kharkov (UA)

(21) Appl. No.: 16/052,047

(22) Filed: Aug. 1, 2018

(30) Foreign Application Priority Data
Jan. 25, 2018 (UA) U201800723
Mar. 20, 2018 (UA) A201802835
Mar. 23, 2018 (RU) 2018110420

(51) Int. Cl. H02K 41/03; E21B 43/12; H02K 1/14; H02K 5/132; H02K 7/14; H02K 15/02

(52) U.S. Cl. CPC H02K 41/031; E21B 43/128; H02K 15/022; H02K 5/132; H02K 7/14; H02K 1/141

(57) ABSTRACT

A claimed invention relates to a field of electrical engineering, in particular to a design of linear electric motors utilized in electric submersible pump units in an oil industry. An essence of a claimed technical solution lies in the fact that construction elements of a stator are performed of a material with a relative temperature expansion equal to a temperature expansion of elements of a moving part of the linear electric motor. Stator sections are made in a form of a frame structure formed of C-shaped transverse ferromagnetic elements (space plates) with radial protrusions. These elements are connected by sectional and intersectional guide elements installed in an axial direction and configured to provide a constant value of a polar pitch and a precise positioning of stator elements relatively to each other.

### CROSS-REFERENCES TO RELATED APPLICATIONS

The present patent application claims priority to Ukrainian Utility Model application u201800723 filed Jan. 25, 2018 (currently issued as a patent No. 125185), Ukrainian patent application a201802835 filed Mar. 20, 2018, Russian Utility Model application 2018110420 filed Mar. 23, 2018.

### FIELD OF INVENTION

The claimed invention relates to a field of electrical engineering, in particular to a design of linear electric motors utilized in electric submersible pump units in an oil industry.

### BACKGROUND

A principle of operation of known linear electric submersible pump units is based on a reciprocating motion of a moving part of a linear electric motor connected to a pump unit plunger under an influence of a traveling electromagnetic field generated in a stator winding of the electric motor.

Advantageously, a stator is performed as a set of toroidal coils installed around a guide element of the movable part of the linear motor. Such a design execution requires a secure fixation of coils in order to ensure their constant and accurate positioning, both relatively to each other and to the moving part of the linear motor, thereby ensuring the constancy of a polar pitch of the stator and a uniform distribution of a magnetic induction in the linear motor.

Also, one of main requirements for operation of the electric motors is an increase in economy, motion smoothness and efficiency. This result is achieved by means of combined windings utilization, at the moment “Slavianka” is the most widely known winding of this type. This winding diagram implies a parallel wye-delta connection of two three-phase windings. Parameters of motors are significantly improved due to the combined windings, in particular, energy efficiency is increased, while utilization of expensive electrotechnical materials is reduced.

An implementation of the sectional framed stator of the linear electric motor with implemented principles of a low-speed electric machines construction in summation with utilization of the combined winding with all its advantages is presented in the claimed invention.

Claim for an invention US2016372994A1 dated 22 Dec. 2016, Int. Cl. H02K 41/02, sets out a stator of a submersible pump unit, comprising a supporting core in a form of a hollow element designed as a guide movable part of a linear drive with at least one inductance coil installed outside the core and fixedly attached by means of a layer of thermo-shrinkable material. Providing that the design involves a presence of the friction layer of the thermo-shrinkable material between the supporting core and at least one inductance coil. Also, the design may comprise ring inserts installable between the coils of inductance.

Disadvantages of the described technical solution may include a method of the inductance coils fixation by means of the thermo-shrinkable material, which does not allow to provide a sufficient accuracy of stator coils positioning relatively to each other, as well as may lead to a change of coils position during operation under the influence of considerable temperatures.

Patent for Utility Model RU 113090 dated 27 Jan. 2012 sets out a synchronous rotating electric machine with combined windings, which includes a six-phase winding consisting of two three-phase combined windings wye-connected and delta-connected respectively with a ratio of a number of wye and delta coils equal to √3, with an equal number of teeth accounted per phase, and the coils of different phases are arranged in different slots so that a resulting flux induction vectors of each adjacent phases forms an angle of 30 electrical degrees. The odd phases are wye-connected, while the even ones are delta-connected or conversely, and their phases outputs, separated by 30 electrical degrees, are interconnected and form phase connection points.

Also US Patent Application US20130038144A1 dated 14 Feb. 2013 sets out an electric motor stator of a submersible pump unit, comprising a plurality of coils and space plates between them, coiled from a single conductor of a certain length with alternating of the three mentioned sets of coils with different current directions. Ends of the stator winding are wye-connected at the end of the last set of coils. A number of the coils in each set is multiple of three. Also according to the disclosed invention, each set of coils comprises a plurality of coils forming adjacent pairs, providing that one of the coils from a pair is coiled in a direction opposite to the other coil of the said pair. The motor described in this embodiment is low-speed, since the fact that according to the description the number of pole pairs of the stator exceeds a number of pole pairs of a moving part (slider).

Disadvantages of the described technical solution may include a fact that in case of wye or delta connection of the windings, the magnetic field of the winding is not sinusoidal and has a step-type shape of a magnetomotive force (MMF) graph, while a power is supplied from a sinusoidal voltage source, which leads to modulation of a draft power of the slider and causes adverse acoustic noises and engine vibrations due to electromagnetic forces. Based on the construction execution, the disadvantages of the described technical solution may include utilization of connecting elements installable between the stator sections, which can affect a positioning accuracy of the stator elements, as well as a performing of the stator of comb elements significantly increases a metal content of the construction and complicates a manufacturing process.

### SUMMARY

The claimed invention aims solving a technical problem constituting an improvement of performance characteristics of the linear electrical motor with permanent magnets with simultaneous provision of a stable draft power with precise positioning of the stator construction elements regardless of a temperature expansion and a mechanical load.

The technical result achieved from the invention embodiment consists in increase of the draft power and a torque output of the electric motor, while providing the sinusoidal graph of the magnetomotive force (MMF), as well as improving accuracy of positioning of the stator construction elements against the elements of the moving part of the electric motor regardless of the relative temperature expansion and a mechanical impact. Also the embodiment of the technical solution contributes to a reduction of a design elements quantity and to an improvement of the manufacturability.

An essence of the claimed technical solution lies in the fact that the construction elements of the stator are performed of a material with the relative temperature expansion equal to the temperature expansion of the elements of the moving part of the linear electric motor. The stator sections are made in the form of the frame structure formed of C-shaped transverse ferromagnetic elements (space plates) with radial protrusions. These elements are connected by sectional and intersectional guide elements installed in an axial direction and configured to provide a constant value of a polar pitch and the precise positioning of the stator elements relatively to each other.

The sectional and intersectional guide elements are performed as laminated perforated strips, arranged in engagement with the radial protrusions of the C-shaped transverse ferromagnetic elements (space plates) with fixation executed by periodically installed lock elements. The C-shaped support elements (space plates) are performed with a transverse slotted hole, executed with a gradual arc-form transition and forming a lengthwise slot for placing connectable ends of the coils upon a stator sections formation.

According to a preferred embodiment, the stator winding comprises a set of coils placed between the C-shaped transverse elements (space plates) of the stator sections and arranged in groups of an equal coils quantity. The coils in groups are placed taking into account an alternate change in a current direction within a same group. The stator winding constitutes a part of a magnetic system comprising a number of stator teeth different from a number of magnetic poles of the movable part of the linear electric motor by a two-fold value, while the resultant magnetic field with a number of magnetic poles of the stator is equal to the number of magnetic poles of the moving part. The coils in the groups are arranged in pairs with an alternation of the wye and delta connections, while forming an angle between vectors of a magnetic flux induction of 90 electrical degrees in each pair, and simultaneously the coil groups of a same phase are shifted relatively to the groups of coils of other phases by 120 electrical degrees.

Also, according to the preferred invention embodiment, the stator winding is performed as a nine-phase one, containing a same number of teeth per phase, and consists of three three-phase windings connected in parallel, two of which are wye-connected and one is delta-connected.

The coil group comprises at least two coils representing one phase and forming one pole, while one of the said pairs of coils is wye-connected and the second is delta-connected with similar coils of other phases, providing that each pair of coils in the group has a reverse polarity with respect to a previous one.

According to the claimed construction a method for manufacturing of the stator comprises performing the stator of sections, construction elements of which are made of a material with the relative temperature expansion equal to the temperature expansion of the elements of the moving part of the linear electric motor; performing the stator sections as the frame structure formed of the C-shaped transverse ferromagnetic elements (space plates) with the radial protrusions, as well as the sectional and intersectional guide elements; installing the set of coils between the C-shaped transverse elements, gathered in groups, placed taking into account the alternate change in the current direction within the same group; arranging the coils in the groups in pairs with an alternation of the wye and delta connections; forming the angle between vectors of the magnetic flux induction of 90 electrical degrees in each pair; shifting the coil groups of the same phase relatively to the groups of coils of the other phases by 120 electrical degrees.

Also, according to the preferred manufacturing embodiment, the stator winding is made of three three-phase windings connected in parallel, two of which are wye-connected and one is delta-connected.

### BRIEF DESCRIPTION OF THE DRAWINGS

An essence of the claimed invention is explained, but is not limited to the following images:

FIG. 1 shows the linear electric submersible pump unit;

FIG. 2 shows a layout of the stator of the linear electrical submersible pump unit;

FIG. 3 shows the stator of the linear electrical submersible pump unit in section;

FIG. 4 shows the C-shaped ferromagnetic space plate (variant 1);

FIG. 5 shows the C-shaped ferromagnetic space plate (variant 2);

FIG. 6 shows the winding diagram of the stator of the linear electrical submersible pump unit;

FIG. 7 shows the graph of the magnetomotive force (MMF) within a nonmagnetic gap.

### DETAILED DESCRIPTION OF THE PREFERRED EMBODIMENT

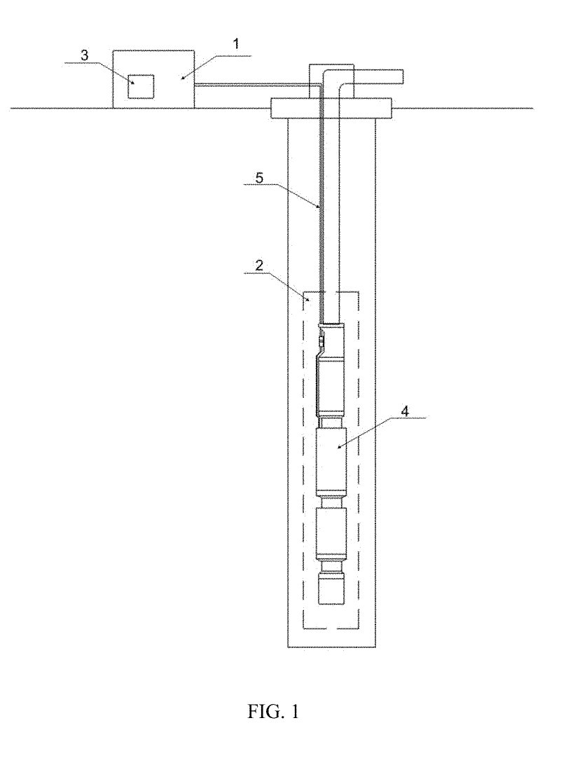

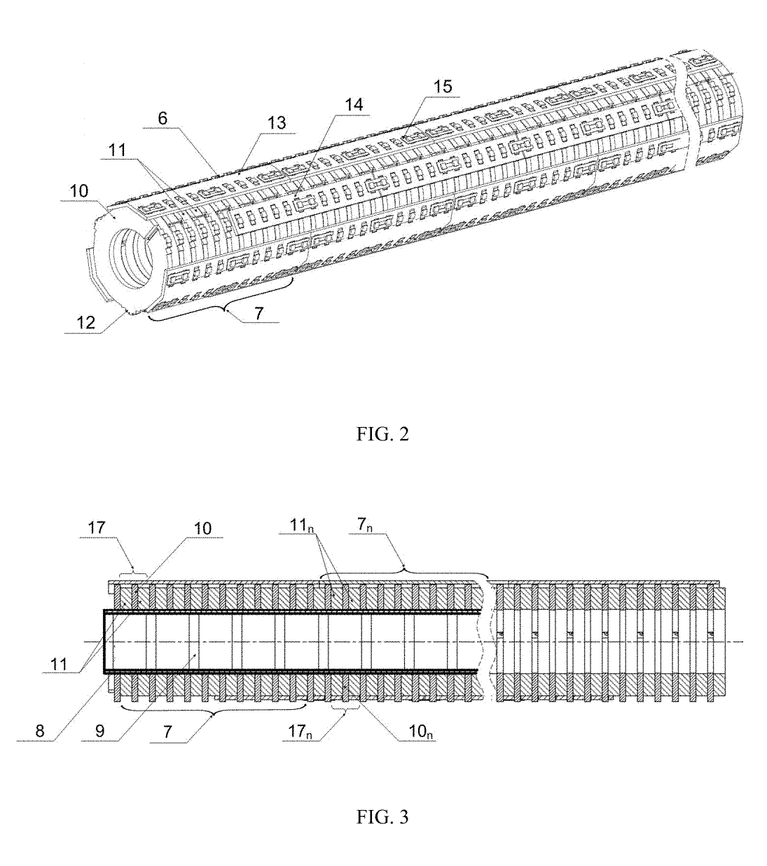

The claimed invention is implemented in the construction of the linear electrical submersible pump unit of a modular design, comprising surface 1 (FIG. 1) and submersible 2 parts. The surface part is represented in a form of surface control unit 3 performed as a three-phase high-frequency regulating inverter and an output transformer connected to linear submersible electric motor 4 by cable line 5. Submersible part 2 (FIG. 1) comprises linear electrical motor 4 with permanent magnets, containing stator 6 (FIG. 2) performed of set of sections 7. Stator sections 7 are formed of annular support elements installed around hollow guide element 8 (FIG. 3) of movable part 9 of the linear electric motor (slider), which are performed as C-shaped transverse ferromagnetic elements (space plates) 10, that separate coils 11, forming the winding with number of magnetic poles equal to p>10. The stator winding includes a spatially-combined composition of the three-phase interdependent parts (windings) wye or delta connected.

According to the preferred embodiment of the invention, the stator construction elements are made of the material with the relative temperature expansion equal to the temperature expansion of the movable part of the linear electric motor. This embodiment allows to perform accurate positioning of the stator elements relatively to the movable part of the linear electric motor (slider), so that the overall temperature expansion does not affect a ratio of geometric dimensions of the stator and slider components, providing constancy of the draft power over a wide range of temperatures.

Stator sections 7 are made in the form of the frame structure formed of C-shaped transverse ferromagnetic elements (space plates) 10 with radial protrusions 12, as well as sectional 13 and intersectional 14 guide elements, mounted around the stator in the axial direction. Guide elements 13, 14 are designed to provide the constant value of the polar pitch and the precise positioning of the stator elements relatively to each other. According to the described embodiment, guide elements 13, 14 are performed as the laminated perforated elements, arranged in engagement with radial protrusions 12 of C-shaped transverse ferromagnetic elements (space plates) 10 with fixation executed by periodically installed lock elements 15. The mentioned lock elements are readily-removable and configured to provide quick assembly by mounting them over guide elements 13, 14 with engaging the teeth with radial protrusions 12. Depending on a design, intersectional guide elements 14 can be performed either as separately installed perforated plates (FIG. 1) or as sectional guide elements 13 installed between adjacent sections (not shown on the images).

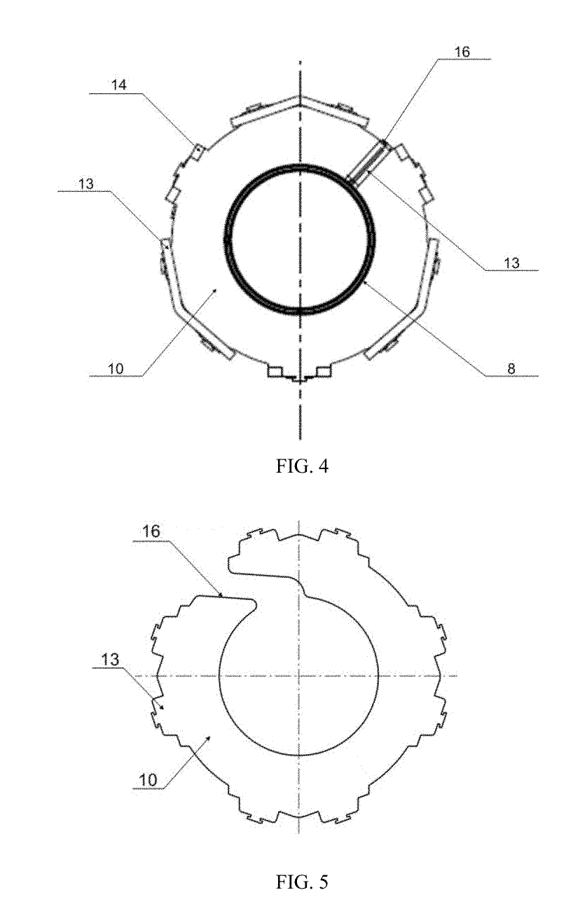

The embodiments of C-shaped support elements (space plates) 10 are shown on FIGS. 4, 5. According to one of the possible embodiments C-shaped transverse ferromagnetic elements (space plates) 10 (FIG. 4) are performed with transverse slotted hole 16 with the gradual arc-form transition and form lengthwise slot 11 for placing the connectable ends of the coils upon the stator sections formation.

Each stator section comprises at least one group 17, 17ₙ (FIG. 3), formed of pair of coils 11, 11ₙ, separated by ferromagnetic space plate 10, 10ₙ. At least one coil of pair 11 of at least one group 17 of first section 7 relating to one of the phases is connected to coils 11ₙ in respective groups 17ₙ of next sections 7ₙ relating to the other phases by means of the wye or delta type connection, providing the alternation and the spatial phase shift of a mains supply voltage.

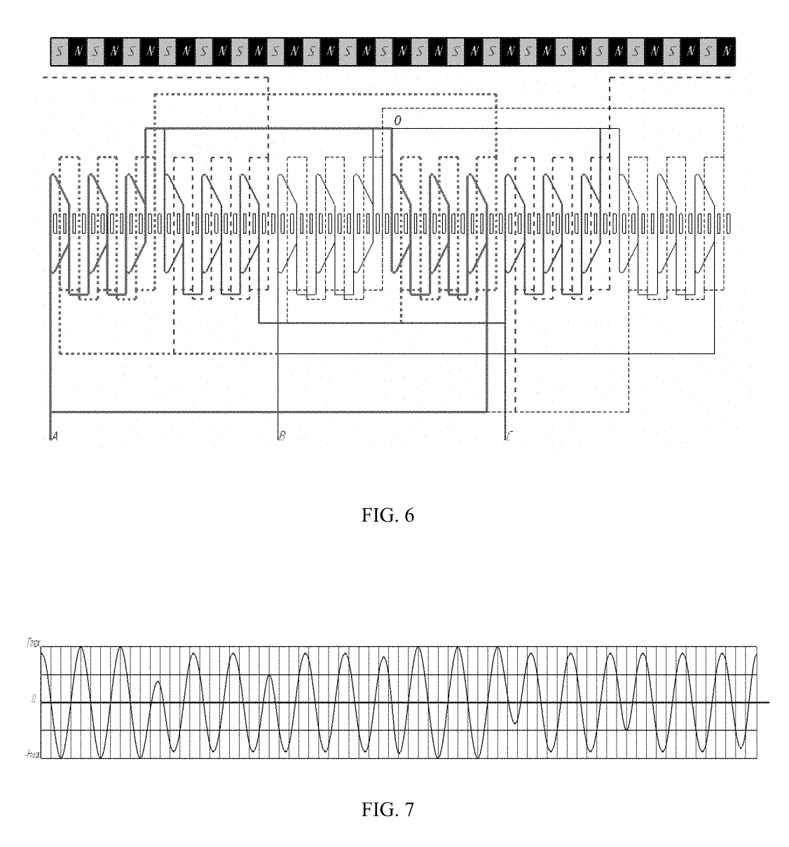

According to the embodiment of the claimed technical solution, the stator winding (FIG. 6) is made of three three-phase windings connected in parallel, two of which are wye-connected (marked with a solid line on the diagram in a form of trapezoids with different line thicknesses for each phase) and one is delta-connected (marked with a dashed line on the diagram in a form of rectangles with different line thicknesses for each phase).

The stator winding comprises set of coils 11 placed between C-shaped transverse elements 10 of stator sections 7 and gathered into groups 17 with equal number of coils arranged taking into account the alternate change in the current direction within the same group. The described stator winding and the slider (shown on FIG. 6 as alternately arranged magnets with S and N poles) constitute the magnetic system comprising the number of stator teeth different from the number of magnetic poles of the movable part of the linear electric motor by the two-fold value, while the resultant magnetic field with a number of magnetic poles of the stator is equal to the number of magnetic poles of the moving part. The coils in the groups are arranged in pairs with the alternation of the wye and delta connections. The angle between vectors of the magnetic flux induction in each pair of coils equals to 90 electrical degrees, while the coil groups of the same phase are shifted relatively to the groups of coils of other phases by 120 electrical degrees.

According to one of the possible embodiments of winding in the group of coils, at least two coils represent one phase and form one pole, while one coil from the said pair is wye-connected and the second one is delta-connected with similar coils of other phases. Also each pair of coils in the group has the reverse polarity with respect to the previous pair.

It is also possible to connect coils to the winding, according to which one part of the set of coils forms wye-connected groups, and the second one forms delta-connected groups with the spatial displacement relative to each other by 90 electrical degrees.

The performance of the stator of the linear motor with the winding (FIG. 6) according to the described invention enables the implementation of the linear electric motor with the number of pole pairs on the slider equal to 2p=38 with the number of slots at the stator equal to z=36 or z=72.

The operation of the linear electric motor with the stator of the claimed design can be described as follows.

On the basis of the fact that the direction vector of the magnetic field generated by the current, flowing along one phase of the stator winding, coincides with the vector of the magnetic field of the slider at one temporal value, and at the other two temporal values it does not coincide, the resultant vector, directed in parallel to the axis of the slider (in the axial direction), appears in the nonmagnetic gap, while a force, approaching to bring the slider into a stable position, starts influencing the slider. This, in turn, leads to an appearance of a driving torque, since the slider is positioned relatively to the stator in such a way that a total value of the magnetic field vectors in the radial direction equals to zero.

A harmonic current flows in the stator winding, while the wye-connected phases are set to the angle of 120° relatively to each other, and the delta-connected phases are arranged analogically. Providing that the delta-connected windings are displaced relatively to the wye-connected windings by a half of the slot pitch at z=36 or by one slot pitch at z=72.

The displacement of the wye-connected windings relatively to the delta-connected windings leads to appearing of a pulsating magnetic field in each tooth, while the total vector of the maximum magnetic flux moves successively along the stator teeth. The magnetic field created by the permanent magnets of the slider is entrained by the magnetic field vector, created by the stator winding, that forms the driving torque, influencing the moving part of the electric motor.

The voltage is applied to the stator windings via a control device (controller), so that the vector of the stator magnetic field is always equal to the vector of the slider magnetic field. The controller operates the current, flowing through the stator windings of the electric motor, namely the vector of the stator magnetic field, by means of a pulse-width modulation (PWM) and thus regulates the torque influencing the slider. The operation is performed in such a manner as to create and maintain the travelling magnetic field, entraining the slider, in a gap between the stator and the slider.

The claimed invention embodiment, involving the combined winding of the electric motor, contributes to an achievement of this technical result, providing an increase in the draft power with an improvement of the output torque of the electric motor. It is also possible to achieve the sinusoidal graph of the magnetomotive force (MMF), as shown in FIG. 7, so that the movable part of the electric motor (slider) motion becomes maximally smooth and its lifetime increases. Performing the stator as the frame sectional construction provides manufacturability of an assembly and contributes to the increase in the accuracy of positioning of the stator construction elements relatively to the moving part of the electric motor, regardless of the relative temperature expansion and the mechanical impact.

The claimed method provides various options and alternative forms of embodiment. A particular embodiment is disclosed in a description and illustrated by means of the given graphic materials. A described embodiment of the invention is not limited to a particular disclosed form and may encompass all possible embodiments, equivalents and alternatives, within the limits of essential features disclosed in the claim.

What is claimed is:

1. A stator of a linear electrical submersible pump unit consisting of a plurality of sections comprising annular support members installed around a hollow guide pipe for a movable part of a linear drive, separating a set of coils forming a winding with a number of magnetic poles p>10, including a spatially combined composition of three-phase interdependent parts (windings) assembled into wye and delta connections, distinct in that structural elements of the stator are made of a material with a relative thermal expansion equal to a thermal expansion of elements of the movable part of the linear drive, while the sections of the stator are performed as a frame structure formed of C-shaped transverse ferromagnetic elements (space plates) with radial protrusions, as well as sectional and intersectional guide elements, installed in an axial direction, designed to provide a constant value of a polar pitch and a precise positioning of the stator elements relatively to each other.

2. The stator of the linear electric submersible pump unit according to claim 1 wherein the sectional and intersectional guide elements are performed as laminated perforated elements arranged in engagement with the radial protrusions of the C-shaped transverse ferromagnetic elements (space plates) with fixation executed by periodically installed lock elements, while the C-shaped support elements (space plates) are performed with a transverse slotted hole with a gradual arc-form transition and form a lengthwise slot for placing connectable ends of the coils upon a stator sections formation.

3. The stator of the linear electric submersible pump unit according to claim 1, wherein the stator winding is performed as a nine-phase one and consists of three three-phase windings connected in parallel, two of which are wye-connected and one is delta-connected.

4. A stator of a linear electrical submersible pump unit consisting of a plurality of sections comprising annular support members installed around a hollow guide pipe for a movable part of a linear drive, separating a set of coils forming a winding with a number of magnetic poles p>10, including a spatially combined composition of three-phase interdependent parts (windings) assembled into wye and delta connections, distinct in that the stator winding is made of the set of coils grouped together and constitutes a part of a magnetic system comprising a number of stator teeth different from a number of magnetic poles of the movable part of the linear electric motor by a two-fold value, while a resultant magnetic field with the number of magnetic poles of the stator is equal to the number of magnetic poles of the moving part, providing that coils in groups are arranged in pairs with an alternation of wye and delta connections, while forming an angle between vectors of a magnetic flux induction of 90 electrical degrees in each pair, and simultaneously coil groups of a same phase are shifted relatively to groups of coils of other phases by 120 electrical degrees.

5. The stator of the linear electric submersible pump unit according to claim 4, wherein the stator winding is performed as a nine-phase one and consists of three three-phase windings connected in parallel, two of which are wye-connected and one is delta-connected.

6. The stator of the linear electric submersible pump unit according to claim 4, wherein the coil group comprises at least two coils representing one phase and forming one pole, while one of the said pairs of coils is wye-connected and another is delta-connected with similar coils of other phases, providing that each pair of coils in the group has a reverse polarity with respect to a previous one.

7. A method for manufacturing a stator of a linear electric submersible pump unit, comprising
performing the stator of sections, structural elements of which are made of a material with a relative temperature expansion equal to a temperature expansion of elements of a movable part of a linear electric motor; executing the stator sections in a form of a frame structure made of C-shaped transverse ferromagnetic elements (space plates) with radial protrusions, as well as sectional and intersectional guide elements;
arranging between the C-shaped transverse elements a set of coils combined into groups and placed taking into account an alternating current direction within a same group;
forming the coils in the groups in pairs with alternation of wye and delta connections;
forming an angle between vectors of a magnetic flux induction of 90 electrical degrees in each pair;
shifting the coil groups of the same phase relatively to the groups of coils of other phases by 120 electrical degrees.

8. The method for manufacturing the stator of the linear electric submersible pump unit according to claim 7, wherein the stator winding is made of three three-phase windings connected in parallel, two of which are wye-connected and one is delta-connected.
